(19) United States
(12) Patent Application Publication
(10) Pub. No.: US 2017/0304807 A1
(43) Pub. Date: Oct. 26, 2017

(54) METHOD FOR PREPARATION OF A FISCHER-TROPSCH CATALYST WITH VAPOR TREATMENT

(71) Applicant: IFP Energies Nouvelles, Rueil-Malmaison Cedex (FR)

(72) Inventors: Dominique DECOTTIGNIES, Saint-Genis-Laval (FR); Antoine FECANT, Brignais (FR); Leonor DUARTE MENDES CATITA, Lyon (FR)

(73) Assignee: IFP Energies Nouvelles, Rueil-Malmaison Cedex (FR)

(21) Appl. No.: 15/529,772

(22) PCT Filed: Oct. 19, 2015
(86) PCT No.: PCT/EP2015/074175

§ 371 Date: May 25, 2017

(30) Foreign Application Priority Data
Nov. 26, 2014 (FR) 14/61480

(51) Int. Cl. B01J 23/75; B01J 37/10; B01J 37/02; B01J 35/10; B01J 35/02; C10G 2/00; B01J 23/00

(52) U.S. Cl. CPC B01J 23/75; C10G 2/332; B01J 37/10; B01J 37/0201; B01J 35/1047; B01J 23/005; B01J 35/1038; B01J 35/1019; B01J 35/1014; B01J 35/023; B01J 35/1042

(57) ABSTRACT

Preparation of a catalyst that comprises an active phase of at least one metal of group VIM that is deposited on an oxide substrate,
a) An oxide substrate that comprises alumina, silica, or a silica-alumina is provided;
b) The oxide substrate of step a) is impregnated by an aqueous or organic solution that comprises at least one metal salt of group VIM that is selected from among cobalt, nickel, ruthenium, and iron, and then the product that is obtained is dried at a temperature of between 60 and 200° C.;

A treatment under water vapor of the solid that is obtained in step b) is carried out at a temperature of between 110 and 195° C. for a length of time of between 30 minutes and 4 hours, in the presence of an air/vapor mixture that comprises between 2 and 50% by volume of water in vapor form.

### TECHNICAL FIELD OF THE INVENTION

This invention relates to the field of Fischer-Tropsch synthesis methods and in particular to the preparation of a catalyst that has an improved reducibility.

### STATE OF THE ART

The Fischer-Tropsch synthesis methods make it possible to obtain a wide range of hydrocarbon fractions starting from the CO+H₂ mixture that is commonly called synthesis gas. The overall equation of the Fischer-Tropsch synthesis can be written in the following manner:

nCO+(2n+1) H₂→CₙH₂ₙ₊₂+nH₂O

The Fischer-Tropsch synthesis is at the heart of the methods for conversion of natural gas, carbon, or biomass into fuels or into intermediate products for the chemical industry. These methods are called GTL (“Gas to Liquids” in the English terminology) in the case of the use of natural gas as the initial feedstock, CTL (“Coal to Liquids” in the English terminology) for carbon, and BTL (“Biomass to Liquids” in the English terminology) for the biomass.

In each of these cases, the initial feedstock is first carbonated to form synthesis gas, a mixture of carbon monoxide, and dihydrogen. The synthesis gas is then transformed for the most part into paraffins using the Fischer-Tropsch synthesis, and these paraffins can then be transformed into fuels by a hydroisomerization-hydrocracking method. For example, transformation methods such as hydrocracking, dewaxing, and hydroisomerization of heavy fractions (C16+) make it possible to produce different types of fuels in the range of middle distillates: diesel fuel (fraction 180-370° C.) and kerosene (fraction 140-300° C.). The lighter C5-C15 fractions can be distilled and used as solvents.

The Fischer-Tropsch synthesis reaction can be carried out in different types of reactors (fixed bed, moving bed, or three-phase bed (gas, liquid, solid), for example of the perfect-mixing autoclave type or bubble column type), and the products of the reaction have in particular the characteristic of being free of sulfur-containing compounds, nitrogen-containing compounds, or aromatic-type compounds.

In an implementation in a bubble-column-type reactor (or “slurry bubble column” in the English terminology, or else “slurry” in a simplified expression), the use of the catalyst is characterized by the fact that the former is divided into a very fine powder state, typically on the order of several tens of micrometers, with this powder forming a suspension with the reaction medium.

The Fischer-Tropsch reaction takes place in a conventional manner between 1 and 4 MPa (10 and 40 bar), at temperatures of traditionally between 200° C. and 350° C. The reaction is exothermic overall, which requires particular attention to the use of the catalyst.

The catalysts that are used for the Fischer-Tropsch synthesis are essentially catalysts based on cobalt or iron, even if other metals can be used. Nevertheless, the cobalt and the iron offer a good performance/price compromise in relation to other metals.

The conventional methods for preparation of the metal substrate catalysts that are used for the Fischer-Tropsch synthesis consist in depositing a metal salt or a metal-ligand coordination complex on the substrate, then in carrying out one or more heat treatment(s) carried out in air, followed by a reducing treatment performed ex-situ or in-situ.

So as to improve the activity of the catalysts that are used for the Fischer-Tropsch synthesis, numerous documents propose modifications for the steps of impregnation and/or drying and/or calcination and/or activation (reduction).

Furthermore, documents are known that disclose methods for preparation of catalysts that are used for the Fischer-Tropsch synthesis, in which methods a vapor treatment step is carried out. In the article that appeared in Topics in Catalysis, 45 (1-4) 2007 by Borg et al., a treatment under an air/water vapor mixture (50% by volume/50% by volume) of a previously dried catalyst precursor is described. This document teaches that the concentration of water vapor during treatment does not influence the reducibility of cobalt.

The patent application WO2011/027104 describes a method for preparation of a cobalt-based Fischer-Tropsch catalyst that has a selectivity of improved formed C₅₊ product, in which method an oxidizing treatment step is carried out under a gas mixture that contains at least 2% water vapor. This step is carried out on a previously reduced catalyst precursor. A last step of activation under reducing gas is necessary for producing the active catalyst by Fischer-Tropsch synthesis.

Finally, the patent application WO2008/122636 describes a method for preparation of a Fischer-Tropsch catalyst, including a step for treatment under water vapor or under liquid water. This treatment under water vapor is carried out using a gas that contains at least 80% of water vapor or with liquid water, on a solid that contains a metal phase that is distributed in a homogeneous way and that is present for the most part in the form of divalent oxide or divalent hydroxide.

The applicant discovered, surprisingly enough, that a pretreatment with water vapor carried out under specific operating conditions makes it possible to prepare catalysts that have an improved reducibility, measured by programmed reduction by temperature RTP (or TPR for “temperature programmed reduction” in the English terminology), which makes it possible to improve their catalytic performances in a Fischer-Tropsch-type method. According to the invention, the vapor treatment (called “steaming” in the English terminology) is carried out on a previously dried catalyst precursor.

The Fischer-Tropsch method is then performed in the presence of a catalyst that has an improved reducibility, i.e., the temperature that is necessary to the reduction of the catalyst is lower than the temperature that is necessary for the reduction of the catalysts of the prior art. Actually, the catalyst that is used in the Fischer-Tropsch synthesis method according to the invention has a reduction in the interaction between a metal of group VIIIB and the substrate in relation to the catalysts of the prior art, which makes possible an increase in the activity.

### Objects of the Invention

The invention relates to a method for preparation of a catalyst that comprises an active phase that comprises at least one metal of group VIIIB that is selected from among cobalt, nickel, ruthenium, and iron, deposited on an oxide substrate, where said method comprises the following steps:
a) An oxide substrate that comprises alumina, silica, or a silica-alumina is provided;
b) The oxide substrate of step a) is impregnated by an aqueous or organic solution that comprises at least one metal salt of group VIIIB that is selected from among cobalt, nickel, ruthenium, and iron, and then the product that is obtained is dried at a temperature of between 60 and 200° C.;
c) A treatment under water vapor of the solid that is obtained in step b) is carried out at a temperature of between 110 and 195° C. for a length of time of between 30 minutes and 4 hours, in the presence of an air/vapor mixture that comprises between 2 and 50% by volume of water in vapor form.

According to a variant, the heat treatment under water vapor is performed at a temperature of between 110 and 190° C., preferably between 110 and 180° C., for a length of time ranging from 30 minutes to 4 hours and with an air/vapor mixture comprising between 20 and 50% by volume of water in vapor form.

According to a first variant of the method according to the invention, a step a′) is carried out between steps a) and b) of said method, a step a′) in which the oxide substrate that is provided in step a) is impregnated by an aqueous or organic solution of a phosphorus precursor, then a drying step is initiated at a temperature of between 60° C. and 200° C., and then a step for calcination of the solid that is obtained is initiated at a temperature of between 200° C. and 1100° C.

According to another variant of the method according to the invention, a step a″) is carried out subsequently between step a) or a′) and b), in which step a″) said substrate that comprises alumina, silica, or a silica-alumina, optionally phosphorus, is impregnated by an aqueous or organic solution that comprises at least one metal salt M or M′ that is selected from the group that consists of magnesium (Mg), copper (Cu), cobalt (Co), nickel (Ni), tin (Sn), zinc (Zn), lithium (Li), calcium (Ca), cesium (Cs), sodium (Na), potassium (K), iron (Fe), and manganese (Mn), and then it is dried and calcined at a temperature of between 700 and 1200° C., in such a way as to obtain a simple spinel MAl₂O₄ or a mixed spinel MₓM′₍₁₋ₓ₎Al₂O₄ that may or may not be partial, where M and M′ are separate metals and where x is between 0 and 1, with the values 0 and 1 themselves being excluded.

Also according to a variant of the method according to the invention, the steps a′) and a″) are carried out simultaneously so as to introduce phosphorus and the metal M or M′ in a single step onto said oxide substrate provided in step a).

Advantageously, the content of metal M or M′ is between 1 and 20% by weight in relation to the total mass of the final substrate.

According to a variant, a step d) for calcination is carried out at a temperature of between 320° C. and 460° C.

According to a variant, a reducing treatment step is carried out after step c) for treatment under vapor and/or step d) of calcination, at a temperature of between 200° C. and 600° C.

Advantageously, the metal content of group VIIIB of the active phase of said catalyst is between 0.5 and 60% by weight in relation to the weight of said catalyst.

Advantageously, the phosphorus content of the oxide substrate is between 0.1% by weight and 10% by weight in relation to the weight of said substrate.

Advantageously, the active phase of said catalyst that comprises at least one metal of group VIIIB is cobalt.

Advantageously, the specific surface area of the oxide substrate is encompassed between 50 m²/g and 500 m²/g, and the pore volume of said oxide substrate, that is measured by mercury porosimetry, is between 0.2 ml/g and 2.0 ml/g.

Advantageously, the oxide substrate is a silica-alumina substrate.

According to a variant, the impregnation step b) of the substrate with the active phase comprises at least one step b′) for depositing at least one dopant that is selected from among a noble metal of groups VIIB or VIIIB, an alkaline element (element of group IA) or an alkaline-earth element (element of group IIA) or an element of group IIIA, by itself or in a mixture, on said oxide substrate.

Advantageously, the size of the catalyst particles is between 10 and 500 micrometers.

### DETAILED DESCRIPTION OF THE INVENTION

In the following description, the groups of chemical elements are provided according to the CAS classification (CRC Handbook of Chemistry and Physics, Editor CRC Press, Editor-in-Chief D. R. Lide, 81^{st} Edition, 2000-2001). For example, group VIIIB according to the CAS classification corresponds to the metals of columns 8, 9, and 10 according to the new IUPAC classification.

The textural and structural properties of the substrate and the catalyst described below are determined by the characterization methods that are known to one skilled in the art. The total pore volume and the pore distribution are determined in this invention by mercury porosimetry (cf. Rouguerol, F.; Rouquerol, J.; Singh, K. “Adsorption by Powders & Porous Solids: Principle, Methodology and Applications,” Academic Press, 1999). More particularly, the total pore volume is measured by mercury porosimetry according to the standard ASTM D4284-92 with a wetting angle of 140°, for example by means of a model apparatus Autopore III™ of the trademark Micromeritics™. The specific surface area is determined in this invention by the B.E.T. method, a method that is described in the same reference work as the mercury porosimetry, and more particularly according to the standard ASTM D3663-03.

### Method for Preparation of the Catalyst

The preparation of the catalyst that is used in the Fischer-Tropsch method according to the invention can be performed by several variants. The preparation of the catalyst in general comprises, in a first step, the preparation of the oxide substrate that comprises alumina, silica, or a silica-alumina, optionally at least one spinel and optionally phosphorus, and then, in a second step, the introduction of the active phase.

The method for preparation of the catalyst that is used in the Fischer-Tropsch method according to the invention comprises the following steps:
a) An oxide substrate that comprises alumina, silica, or a silica-alumina is provided;
b) The oxide substrate of step a) is impregnated by an aqueous or organic solution that comprises at least one metal salt of group VIIIB that is selected from among cobalt, nickel, ruthenium, and iron, preferably cobalt, and then the product that is obtained is dried at a temperature of between 60 and 200° C.;
c) The product that is obtained in step b) is treated under water vapor at a temperature of between 110 and 195° C., preferably between 110 and 190° C., and in an even more preferred manner between 110 and 180° C., for a length of time of 30 minutes to 4 hours and with an air/vapor mixture, with said mixture comprising between 2 and 50% by volume of water in vapor form, preferably between 20 and 50% by volume of water in vapor form.

More particularly, according to step a), a substrate is provided that comprises alumina, silica, or a silica-alumina. When the substrate is a silica-alumina, the silica content SiO₂ can vary from 0.5% by weight to 30% by weight, in a preferred manner from 1% by weight to 30% by weight, and in an even more preferred manner from 1.5 to 20% by weight in relation to the weight of the substrate. Preferably, a silica-alumina substrate is provided. Such a substrate can be purchased or manufactured, for example by spraying an alumina precursor in the presence of a compound that comprises silicon. The substrate that comprises alumina and silica can be provided by any means that is known to one skilled in the art, for example by impregnation of an organosilyl-containing compound such as TEOS (tetraethylorthosilicate) on an alumina. In this case, this impregnation, followed by a drying and a calcination, is preliminary to step a) that is described above.

In a particular embodiment of the method according to the invention, a step a′) in which the oxide substrate that is provided in step a) is impregnated by an aqueous or organic solution of a phosphorus precursor is carried out between steps a) and b) of the method according to the invention, and then a step for drying and calcinating the solid that is obtained is initiated. The impregnation step a′) is advantageously carried out by at least one solution that contains at least one phosphorus precursor. In particular, step a′) can advantageously be carried out by dry impregnation, by excess impregnation, or else by deposition-precipitation according to methods that are well known to one skilled in the art. In a preferred manner, said impregnation step is carried out by dry impregnation, preferably at ambient temperature. Said impregnation step consists in putting said substrate into contact with at least one solution that contains at least one phosphorus precursor, whose volume is equal to the pore volume of said substrate that is to be impregnated. This solution contains the phosphorus precursor at the desired concentration to obtain in the final substrate the targeted phosphorus content, preferably between 0.1% by weight and 10% by weight, in a preferred manner between 0.3% by weight and 5% by weight, and in a particularly preferred manner between 0.5 and 3% by weight in relation to the weight of the substrate.

The phosphorus precursor that is used can be any phosphorus precursor that is known to one skilled in the art. It is advantageously possible to use phosphoric acid and its phosphate derivatives, phosphorus acid and its phosphonate derivatives, phosphinic acid and its phosphinate derivatives, phosphonic acid and its phosphonate derivatives, pyrophosphoric acid and its phosphate derivatives, diphosphorus pentoxide, phosphines, phosphites, phosphinites, or phosphonites. In a preferred manner, the phosphoric acid in aqueous solution is used.

After impregnation of the phosphorus precursor, the solid that is obtained is then dried and calcined. The drying is advantageously performed at a temperature of between 60° C. and 200° C., preferably for a length of time that ranges from 30 minutes to 48 hours. The calcination is advantageously performed at a temperature of between 200° C. and 1100° C., preferably for a length of time that ranges from 1 hour to 24 hours, and in a preferred manner from 2 hours to 8 hours. The calcination is in general performed under an oxidizing atmosphere, for example in air, or in oxygen-depleted air; it can also be performed at least in part in nitrogen.

All of the steps of drying and calcination that are described in this description can be carried out by any technique that is known to one skilled in the art: fixed bed, fluidized bed, oven, muffle furnace, rotary furnace.

In still another particular embodiment of the method according to the invention, and more particularly when the substrate comprises alumina, a step a″) is carried out between step a) or a′) and b), in which step a″) the substrate is impregnated, preferably dry-impregnated, by an aqueous or organic solution that comprises at least one metal salt M or M′ that is selected from the group that consists of magnesium (Mg), copper (Cu), cobalt (Co), nickel (Ni), tin (Sn), zinc (Zn), lithium (Li), calcium (Ca), cesium (Cs), sodium (Na), potassium (K), iron (Fe), and manganese (Mn), preferably cobalt, nickel, magnesium, calcium, and zinc, and in a very preferred manner cobalt and nickel, and in a particularly preferred manner cobalt, and then a step of drying and a step of calcination are initiated, in such a way as to obtain a simple spinel MAl₂O₄ or a mixed spinel MₓM′₍₁₋ₓ₎Al₂O₄, which may or may not be partial, where M and M′ are separate metals and where x is between 0 and 1, with the values 0 and 1 themselves being excluded.

The metal M or M′ is brought into contact with the substrate by means of any metal precursor that is soluble in the aqueous phase. In a preferred manner, the precursor of the metal of group VIIIB is introduced in aqueous solution, preferably in the form of nitrate, carbonate, acetate, chloride, oxalate, complexes formed by a polyacid, or an acid-alcohol and its salts, complexes formed with acetylacetonates, or any other inorganic derivative that is soluble in aqueous solution, which is brought into contact with said substrate. In the preferred case where the metal M is cobalt, the cobalt precursor that is advantageously used is cobalt nitrate, cobalt oxalate, or cobalt acetate.

The content of metal M or M′ is advantageously between 1 and 20% by weight and preferably between 2 and 10% by weight in relation to the total mass of the final substrate.

The drying is advantageously performed at a temperature of between 60° C. and 200° C., preferably for a length of time ranging from 30 minutes to 48 hours.

The calcination is performed at a temperature of between 700 and 1200° C., preferably between 850 and 1200° C., and in a preferred manner between 850 and 900° C., in general for a length of time of between one hour and 24 hours and preferably between 2 hours and 5 hours. The calcination is in general performed under an oxidizing atmosphere, for example in air, or in oxygen-depleted air; it can also be performed at least in part in nitrogen. It makes it possible to transform the precursors M and M′ and the alumina into a spinel-type structure (aluminate of M and M′).

According to a variant, the calcination can also be performed in two steps: said calcination is advantageously carried out at a temperature of between 300° C. and 600° C. in air for a length of time of between one half-hour and three hours, and then at a temperature of between 700° C. and 1200° C., preferably between 850 and 1200° C. and in a preferred manner between 850 and 900° C., in general for a length of time of between one hour and 24 hours, and preferably between 2 hours and 5 hours.

Thus, at the end of said step a″), said substrate also comprises a simple spinel MAl₂O₄ or a mixed spinel MₓM′₍₁₋ₓ₎Al₂O₄, which may or may not be partial, in which the metals M and M′ are in the form of aluminates. The preparation of catalyst comprising a substrate comprising phosphorus and/or a spinel makes it possible to improve the hydrothermal and mechanical resistance of the catalyst in a Fischer-Tropsch method. The metal or metals M and M′, when they are in spinel form, are not reducible under the usual conditions of reduction and are not part of the active phase.

Also according to another variant for preparation of the catalyst according to the invention, the steps a′) and a″) are carried out simultaneously so as to introduce phosphorus and the metal M or M′ in a single step onto the substrate. The simultaneous presence of alumina, silica, phosphorus and a spinel in the substrate imparts to the final catalyst a hydrothermal resistance and a resistance to attrition that are much higher than catalysts of the state of the art that contain only one, two, or three of these four components.

Also according to another variant for preparation of the catalyst, silica precursors of the metal M or M′ and phosphorus are introduced simultaneously into the substrate that comprises alumina.

In another variant embodiment, the substrate is prepared by co-precipitation of an aqueous solution that contains the elements Al, Si, P, M or M′, for example in the form of nitrate for aluminum and M or M′, and acid or acid salt for phosphorus and silicon, by an aqueous solution of carbonate or hydrogen carbonate, followed by a washing, a drying, and a calcination.

It is also possible to prepare the substrate by a sol-gel method, or else by complexing an aqueous solution that contains the elements M or M′, Al, Si and P by at least one alpha-alcohol acid that is added at a rate of 0.5 to 2 mol of acid per mol of elements M or M′, Al, Si and P, followed by a vacuum drying that leads to obtaining a homogeneous vitreous substance, and then a calcination.

The specific surface area of the oxide substrate comprising alumina, silica or a silica-alumina, optionally comprising at least one spinel as described above and optionally phosphorus, is in general between 50 m²/g and 500 m²/g, preferably between 100 m²/g and 300 m²/g, in a more preferred way between 110 m²/g and 250 m²/g. The pore volume of said substrate is in general between 0.2 ml/g and 2.0 ml/g, and preferably between 0.4 ml/g and 1.5 ml/g.

The oxide substrate that comprises alumina, silica, or a silica-alumina, optionally comprising at least one spinel as described above and optionally phosphorus, can also comprise a simple oxide that is selected from among titanium oxide (TiO2), cerium oxide (CeO2), and zirconium oxide (ZrO2), by itself or in a mixture.

The substrate on which said active phase is deposited can have a morphology in the form of balls, extrudates (for example in trilobed or quadrilobed form), or pellets, in particular when said catalyst is used in a reactor that operates in a fixed bed, or can have a morphology in the form of powder of variable grain size, in particular when said catalyst is used in a bubble-column-type reactor.

According to step b), the impregnation of the substrate that is obtained from step a), and optionally step a′) and/or step a″) is carried out by at least one solution that contains at least one precursor of a metal of group VIIIB that is selected from among cobalt, nickel, ruthenium, and iron. In a preferred manner, the metal of group VIIIB is cobalt. In particular, said step can advantageously be carried out by dry impregnation, by excess impregnation, or else by deposition-precipitation according to methods that are well known to one skilled in the art. In a preferred manner, said impregnation step is carried out by dry impregnation, preferably at ambient temperature. Said impregnation step consists in putting said oxide substrate into contact with at least one solution that contains at least one precursor of said metal of group VIIIB, whose volume is equal to the pore volume of said substrate that is to be impregnated. This solution contains the metal precursor of the metal or metals of group VIIIB at the desired concentration to obtain in the final catalyst the targeted metal content, advantageously a metal content of between 0.5 and 60% by weight, and preferably between 5 and 30% by weight in relation to the weight of the catalyst.

The metal or metals of group VIIIB are brought into contact with the substrate by means of any metal precursor that is soluble in the aqueous phase or in the organic phase. When it is introduced into organic solution, the precursor of the metal of group VIIIB is preferably oxalate or acetate of said metal of group VIIIB. In a preferred manner, the precursor of the metal of group VIIIB is introduced in aqueous solution, preferably in the form of nitrate, carbonate, acetate, chloride, oxalate, complexes formed by a polyacid or an acid-alcohol and its salts, complexes formed with the acetylacetonates, or any other inorganic derivative that is soluble in aqueous solution, which is brought into contact with said substrate. In the preferred case where the metal of group VIIIB is cobalt, the cobalt precursor that is advantageously used is cobalt nitrate, cobalt oxalate, or cobalt acetate. In the most preferred manner, the precursor that is used is cobalt nitrate.

The impregnation of said active phase of step b) can be performed in a single step or in several steps of impregnation. In the case of high metal contents, the impregnation in two steps and even in three steps is preferred. Between each of the impregnation steps, it is preferred to perform at least one additional step of drying, optionally followed by a step for treatment under water vapor under the conditions that are described above, and/or optionally a calcination step under the conditions that are described below.

Said impregnation step b) of the substrate with the active phase can also advantageously comprise at least one step b′) that consists in depositing at least one dopant that is selected from among a noble metal of groups VIIB or VIIIB, an alkaline element (element of group IA) or an alkaline-earth element (element of group IIA) or an element of group IIIA, by itself or in a mixture, on said oxide substrate. The impregnation step b) of the substrate with the active phase and the step b′) for deposition of at least one dopant can be carried out concomitantly or successively. The deposition of the dopant on the substrate can advantageously be carried out by any method that is known to one skilled in the art, preferably by impregnation of said oxide substrate by at least one solution that contains at least one precursor of said dopant, and preferably by dry impregnation or by excess impregnation. This solution contains at least one precursor of said dopant at the desired concentration for obtaining in the final catalyst the targeted dopant content, advantageously a dopant content of between 20 ppm and 1% by weight, and preferably between 0.01 to 0.5% by weight in relation to the weight of the catalyst. Below, the catalyst that contains the dopant is dried and then treated under water vapor and optionally calcined under the same conditions as those described in the steps of drying and calcination during the impregnation of the active phase. The impregnation of the active phase and of the dopant can also be performed by a single solution (co-impregnation).

The catalyst precursor thus obtained is then dried. The drying is advantageously performed at a temperature of between 60° C. and 200° C., preferably for a length of time that ranges from 30 minutes to 48 hours. Drying is defined in terms of this invention as any drying that is performed under a dry gaseous atmosphere, i.e., under a gaseous atmosphere without the addition of water. For this purpose, it is possible to use any type of gas or mixture of dry gas relative to the different components of said catalyst. By way of example, it is possible to cite nitrogen, argon, helium, xenon, and air.

According to step c), the catalyst precursor that is obtained in step b) undergoes a heat treatment under water vapor. More particularly, the heat treatment under water vapor is advantageously performed at a temperature of between 110 and 195° C., preferably between 110 and 190° C., and in a preferred manner between 110 and 180° C., for a length of time that ranges from 30 minutes to 4 hours and with an air/vapor mixture that comprises between 2 and 50% by volume of water in vapor form, preferably between 20 and 50% by volume of water in vapor form. The flow rate of the air/vapor mixture is between 0.1 and 20 L/h/g, preferably between 0.2 and 5 L/h/g. Step c) for heat treatment under water vapor is a technique that is known to one skilled in the art. The heat treatment under water vapor can be carried out by means of a vaporizer. The applicant noted that the reducibility of the catalyst is significantly improved when the temperature of the heat treatment under water vapor and the length of time of the treatment are within the ranges of values specified above.

After step c) of the method according to the invention, the product that is obtained can optionally be calcined according to a step d). The calcination is advantageously carried out at a temperature of between 320° C. and 460° C., preferably between 350 and 440° C., and in a preferred manner between 360 and 420° C. It is preferably carried out for a length of time of between 15 minutes and 15 hours, and preferably between 30 minutes and 12 hours, and in an even more preferred manner between 1 hour and 6 hours. The calcination is in general performed under a dry oxidizing atmosphere, i.e., under an atmosphere without an addition of water, for example in air, or in oxygen-depleted air; it can also be performed at least in part in nitrogen.

Prior to its use in the Fischer-Tropsch synthesis reaction, the catalyst in general undergoes a reducing treatment, for example in pure or dilute hydrogen, at a high temperature, intended to activate the catalyst and to form metal particles in the zero valent state (in metal form). This treatment can be performed in situ (in the same reactor as the one where the Fischer-Tropsch synthesis is done) or ex situ before being loaded into the reactor. The temperature of this reducing treatment is preferably between 200° C. and 600° C., and its length of time is in general between 2 and 20 hours.

### Fischer-Tropsch Method

The Fischer-Tropsch method makes possible the production of essentially linear and saturated C5⁺ hydrocarbons. In accordance with the invention, essentially linear and saturated C5⁺ hydrocarbons are defined as hydrocarbons whose proportion of hydrocarbon compounds having at least 5 carbon atoms per molecule represents at least 50% by weight, preferably at least 80% by weight, of all of the hydrocarbons that are formed, with the total content of olefinic compounds that are present from among said hydrocarbon compounds having at least 5 carbon atoms per molecule being less than 15% by weight. The hydrocarbons that are produced by the method of the invention are thus essentially paraffinic hydrocarbons, whose fraction having the highest boiling points can be converted with a high yield into middle distillates (diesel fuel and kerosene fractions) by a catalytic hydroconversion method such as hydrocracking and/or hydroisomerization.

In a preferred manner, the feedstock that is used for the implementation of the method of the invention consists of the synthesis gas that is a mixture of carbon monoxide and hydrogen with H₂/CO molar ratios that can vary between 0.5 and 4 based on the manufacturing method from which it is obtained. The H₂/CO molar ratio of the synthesis gas is in general close to 3 when the synthesis gas is obtained starting from the method for vapor reforming of hydrocarbons or alcohol. The H₂/CO molar ratio of the synthesis gas is on the order of 1.5 to 2 when the synthesis gas is obtained from a partial oxidation method. The H₂/CO molar ratio of the synthesis gas is in general close to 2.5 when it is obtained from an autothermal reforming method. The H₂/CO molar ratio of the synthesis gas is in general close to 1 when it is obtained from a method for gasification and reforming of hydrocarbons with CO₂ (called dry reforming).

The Fischer-Tropsch method according to the invention is done under a total pressure of between 0.1 and 15 MPa, preferably between 0.5 and 10 MPa, under a temperature of between 150 and 350° C., preferably between 180 and 270° C. The hourly volumetric flow rate is advantageously between 100 and 20,000 volumes of synthesis gas per volume of catalyst and per hour (100 to 20,000 h⁻¹) and preferably between 400 and 10,000 volumes of synthesis gas per volume of catalyst and per hour (400 to 10,000 h⁻¹).

The Fischer-Tropsch method according to the invention can be performed in reactors of the following types: perfectly stirred autoclave, boiling bed, bubble column, fixed bed, or moving bed. Preferably, it is performed in a bubble-column-type reactor.

Thus, the size of the grains of the catalyst used in the Fischer-Tropsch method can be between several microns and 2 millimeters. Typically, for use in a three-phase “slurry” reactor (with a bubble column), the catalyst is finely divided and is in the form of particles. The size of the catalyst particles will be between 10 and 500 micrometers (m), in a preferred manner between 10 and 300 μm, and in a very preferred manner between 20 and 150 μm, and in an even more preferred manner between 20 and 120 μm.

To illustrate the invention and to make it possible for one skilled in the art to execute it, we present below various embodiments of the method for preparation of a catalyst that is used for the Fischer-Tropsch synthesis; however, this would not limit the scope of the invention.

### Example 1: Preparation of Catalysts A to C (For Comparison) and Catalysts D to F (According to the Invention)

Catalyst A (Non-Compliant): Catalyst 13% Co on Silica-Alumina Stabilized by 5% Co in Aluminate Form (Spinel) Without Treatment Under Water vapor

A catalyst A is prepared by dry impregnation of an aqueous solution of cobalt nitrate on a silica-alumina (Siralox®, provided by Sasol) in powder form (mean grain size=90 μm) of 170 m²/g. After 12 hours of drying in an oven at 120° C., the solid is calcined for 4 hours at 800° C. under a stream of air in a flushed-bed-type reactor. This calcination at high temperature makes it possible to form a cobalt aluminate spinel phase (5% by weight of cobalt). In this substrate that is stabilized by cobalt in spinel form, a cobalt nitrate solution is impregnated. The solid that is obtained is then dried in an oven for 12 hours at 80° C., and then calcined in air in a tubular fixed-bed reactor at 420° C. for 2 hours. The final catalyst, which contains 13.7% by weight of cobalt (the content of Co that is present in the spinel phase being encompassed therein) and a maximum theoretical content of reducible cobalt of 8.7% by weight, is obtained under the reduction conditions described above. The reducible cobalt content exhibits the active phase and is obtained by a programmed reduction by temperature RTP (or TPR for “temperature programmed reduction” in the English terminology).

Catalyst B (Non-Compliant): Catalyst 13% Co on Silica-Alumina Stabilized by 5% Co in Aluminate form (Spinel) with Treatment Under Water Vapor at 400° C. for 2 Hours

A catalyst B is prepared by dry impregnation of an aqueous solution of cobalt nitrate on a silica-alumina (Siralox®, provided by Sasol) in powder form (mean grain size=90 μm) of 170 m²/g. After 12 hours of drying in an oven at 120° C., the solid is calcined for 4 hours at 800° C. under a stream of air in a flushed-bed-type reactor. This calcination at high temperature makes it possible to form a cobalt aluminate spinel phase (5% by weight of cobalt). In this substrate that is stabilized by cobalt in spinel form, a cobalt nitrate solution is impregnated. The solid that is obtained is then dried in an oven for 12 hours at 80° C. It is then treated at 400° C. for 2 hours in a tubular reactor under a stream of gas of 1.5 L/h/g containing 50% by volume of water and 50% by volume of air. The final catalyst, which contains 13.8% by weight of cobalt (the content of Co that is present in the spinel phase being encompassed therein) and a maximum theoretical content of reducible cobalt of 8.8% by weight, is obtained.

Catalyst C (Non-Compliant): Catalyst 13% Co on Silica-Alumina Stabilized by 5% Co in Aluminate Form (Spinel) with Treatment Under Water Vapor at 190° C. for 10 Hours

A catalyst C is prepared by dry impregnation of an aqueous solution of cobalt nitrate on a silica-alumina (Siralox®, provided by Sasol) in powder form (mean grain size=90 μm) of 170 m²/g. After 12 hours of drying in an oven at 120° C., the solid is calcined for 4 hours at 800° C. under a stream of air in a flushed-bed-type reactor. This calcination at high temperature makes it possible to form a cobalt aluminate spinel phase (5% by weight of cobalt). In this substrate that is stabilized by cobalt in spinel form, a cobalt nitrate solution is impregnated. The solid that is obtained is then dried in an oven for 12 hours at 80° C. It is then treated at 190° C. for 10 hours in a tubular reactor under a stream of gas of 1.1 L/h/g containing 50% by volume of water and 50% by volume of air. The final catalyst, which contains 13.5% by weight of cobalt (the content of Co that is present in the spinel phase being encompassed therein) and a maximum theoretical content of reducible cobalt of 8.5% by weight, is obtained.

Catalyst D (compliant): Catalyst 13% Co on Silica-Alumina Stabilized by 5% Co in Aluminate Form (Spinel) With Treatment Under Water Vapor at 190° C. for 1 Hour

A catalyst D is prepared by dry impregnation of an aqueous solution of cobalt nitrate on a silica-alumina (Siralox®, provided by Sasol) in powder form (mean grain size=90 μm) of 170 m²/g. After 12 hours of drying in an oven at 120° C., the solid is calcined for 4 hours at 800° C. under a stream of air in a flushed-bed-type reactor. This calcination at high temperature makes it possible to form a cobalt aluminate spinel phase (5% by weight of cobalt). In this substrate that is stabilized by cobalt in spinel form, a cobalt nitrate solution is impregnated. The solid that is obtained is then dried in an oven for 12 hours at 80° C. It is then treated at 190° C. for 1 hour in a tubular reactor under a stream of gas of 1 L/h/g containing 50% by volume of water and 50% by volume of air. The final catalyst, which contains 13.7% by weight of cobalt (the content of Co that is present in the spinel phase being encompassed therein) and a maximum theoretical content of reducible cobalt of 8.7% by weight, is obtained.

### Catalyst E (Compliant): Catalyst 13% Co on Silica-Alumina Stabilized by 5% Co in Aluminate Form (Spinel) With Treatment Under Water Vapor at 180° C. for 2 Hours

A catalyst E is prepared by dry impregnation of an aqueous solution of cobalt nitrate on a silica-alumina (Siralox®, provided by Sasol) in powder form (mean grain size=90 μm) of 170 m²/g. After 12 hours of drying in an oven at 120° C., the solid is calcined for 4 hours at 800° C. under a stream of air in a flushed-bed-type reactor. This calcination at high temperature makes it possible to form a cobalt aluminate spinel phase (5% by weight of cobalt). In this substrate that is stabilized by cobalt in spinel form, a cobalt nitrate solution is impregnated. The solid that is obtained is then dried in an oven for 12 hours at 80° C. It is then treated at 180° C. for 2 hours in a tubular reactor under a stream of gas of 1 L/h/g containing 50% by volume of water and 50% by volume of air. The final catalyst, which contains 13.4% by weight of cobalt (the content of Co that is present in the spinel phase being encompassed therein) and a maximum theoretical content of reducible cobalt of 8.4% by weight, is obtained.

### Catalyst F (Non-Compliant): Catalyst 8% Co on Silica-Alumina With Treatment Under Water Vapor at 180° C. for 2 Hours

A catalyst F is prepared by dry impregnation a solution of cobalt nitrate on a silica-alumina. The solid that is obtained is then dried in an oven for 12 hours at 80° C. It is then treated at 180° C. for 2 hours in a tubular reactor under a stream of gas of 1 L/h/g containing 50% by volume of water and 50% by volume of air. The final catalyst, which contains 8.1% by weight of theoretically reducible cobalt, is obtained.

### Example 2: Comparison of the Rates of Reduction of Catalysts A to F

The rate of reduction (TR) of a catalyst is defined as being the reduced cobalt percentage after the step for reduction of the catalyst. The reduction rate (TR) corresponds to the ratio between the reduced cobalt quantity (Q1) and the theoretically reducible cobalt quantity that is present in the catalyst (Q2), or TR (%)=(Q1/Q2)×100.

The measurement of the quantity of reducible cobalt Q2 in these oxide catalysts is carried out by performing a programmed reduction by temperature RTP (or TPR for “temperature programmed reduction” in the English terminology). The TPR is known to one skilled in the art and is described in, for example, the article “Oil & Gas Science and Technology,” FPI Rev., Vol. 64 (2009), No. 1, pp. 11-12.

The TPR consists in treating a sample of 500 mg of catalyst under a gas flow rate of 58 Nml/minute, whose volumetric composition is 5% H₂ diluted in helium with a temperature rate of climb of 5° C./minute between 25 and 800° C., and in measuring the total quantity of consumed hydrogen (V1), which is proportional to the quantity of reducible cobalt. The final catalysts A to F are then reduced in a tubular furnace under a stream of pure hydrogen at 400° C. for 16 hours with a VVH (hourly volumetric flow rate) of 2 Nl/h/g. They are then discharged in air: a fraction of the reduced cobalt reoxidizes upon contact with air; the reduced catalysts are thus passivated. The measurement of the reduced cobalt quantity Q1 is carried out by performing a TPR on these passivated reduced catalysts. The TPR consists in treating a sample of 500 mg of catalyst under a gas flow rate of 58 Nml/minute, whose volumetric composition is 5% H₂ diluted in helium with a temperature rate of climb of 5° C./minute between 25 and 800° C. and in measuring:
The quantity of hydrogen (V2) that is consumed between 25 and 400° C., proportional to the quantity of passivated cobalt; and
The quantity of hydrogen (V3) that is consumed between 400 and 800° C., linked to the reduction of the fraction of non-reduced cobalt, proportional to the quantity of non-reduced cobalt, in the form CoO.

The reduction rate TR (in %) is calculated by the following mathematical formula

$$TR = ( \frac{0.75 \times [ V 1 - V 3 ]}{0.75 \times V 1} ) \times 100 \qquad ( 1 )$$

The reduction rates of the solids A to F were measured according to the operating procedure described above and are provided in Table 1.

TABLE 1
Reduction Rate (%)

| | |
|---|---|
| Operating Conditions of the Step | Reduction |
| for Treatment Under Vapor | Rate % |

Comparison Catalysts:

| | | |
|---|---|---|
| A | None | 48 |
| B | 400° C./2 hours/50% by volume of | 35 |
| | water | |
| C | 190° C./10 hours/50% by volume of | 38 |
| | water | |

Catalysts According to the Invention:

| | | |
|---|---|---|
| D | 190° C/1 hour/50% by volume of | 75 |
| | water | |
| E | 180° C./2 hours/50% by volume of | 62 |
| | water | |
| F | 180° C./2 hours/50% by volume of | 70 |
| | water | |

The catalysts D to F according to the invention all have reduction rates that are higher than those of the catalysts that are not in compliance with the invention A, B, and C.

### Example 3: Catalytic Performance of Catalysts B to F Using the Fischer-Tropsch Method

Before being successively tested in terms of synthesis gas conversion, the catalysts B to F are reduced ex situ under a stream of pure hydrogen at 400° C. for 16 hours with an hourly volumetric flow rate of 2 Nl/h/g in a tubular reactor. Once the catalyst is reduced, it is discharged under an argon atmosphere and coated in Sasolwax® to be stored protected from air before the test. The Fischer-Tropsch synthesis reaction is done in a slurry-type reactor that runs continuously and operates with a concentration of 10% (by volume) of catalyst in the slurry phase.

Each of the catalysts is in powder form with a diameter of between 30 and 170 μm.

The test conditions are as follows: temperature=230° C.; total pressure=2 MPa; H₂/CO molar ratio=2.

The conversion of the CO is maintained between 45 and 50% for the entire duration of the test.

The test conditions are adjusted so as to be at an iso-conversion of CO regardless of the activity of the catalyst.

The results, in terms of activity, were calculated for the catalysts B to F in relation to the catalyst B that is used as reference, and they appear in Table 1.

The results of Table 2 show the catalytic performances of the catalysts B to F in terms of activity. It seems that the catalysts D, E, and F according to the invention have significant gains in activity compared to the comparison catalysts B and C.

TABLE 2
Catalytic Performance

| | |
|---|---|
| | Relative Activity |
| Operating Conditions | After 300 Hours |
| of the Step for | of Testing under a |
| Treatment Under Vapor | Syngas Feedstock |

Comparison Catalysts:

| | | |
|---|---|---|
| B | 400° C./2 hours/50% | 100 |
| | by volume of water | |
| C | 190° C./10 hours/50% | 120 |
| | by volume of water | |

Catalysts According to the Invention:

| | | |
|---|---|---|
| D | 190° C./1 hour/50% | 250 |
| | by volume of water | |
| E | 180° C./2 hours/50% | 178 |
| | by volume of water | |
| F | 180° C./2 hours/50% | 240 |
| | by volume of water | |

1. Method for preparation of a catalyst that comprises an active phase that comprises at least one metal of group VIIIB that is selected from among cobalt, nickel, ruthenium, and iron, deposited on an oxide substrate, where said method comprises the following steps:
a) An oxide substrate that comprises alumina, silica, or silica-alumina is provided;
b) The oxide substrate of step a) is impregnated by an aqueous or organic solution that comprises at least one metal salt of group VIIIB that is selected from among cobalt, nickel, ruthenium, and iron, and then the product that is obtained is dried at a temperature of between 60 and 200° C.;
c) A treatment under water vapor of the solid that is obtained in step b) is carried out at a temperature of between 110 and 195° C. for a length of time of between 30 minutes and 4 hours, in the presence of an air/vapor mixture that comprises between 2 and 50% by volume of water in vapor form.

2. Method according to claim 1, characterized in that the heat treatment under water vapor is performed at a temperature of between 110 and 190° C., for a length of time that ranges from 30 minutes to 4 hours and with an air/vapor mixture that comprises between 20 and 50% by volume of water in vapor form.

3. Method according to Claim characterized in that a step a′) is carried out between steps a) and b) of said method, a step a′) in which the oxide substrate that is provided in step a) is impregnated by an aqueous or organic solution of a phosphorus precursor, then a drying step is initiated at a temperature of between 60° C. and 200° C., and then a step for calcination of the solid that is obtained is initiated at a temperature of between 200° C. and 1100° C.

4. Method according to claim 1, characterized in that a step a″) is carried out subsequently between step a) or a′) and b), in which step a″) said substrate that comprises alumina, silica, or a silica-alumina, optionally phosphorus, is impregnated by an aqueous or organic solution that comprises at least one metal salt M or M′ that is selected from the group that consists of magnesium (Mg), copper (Cu), cobalt (Co), nickel (Ni), tin (Sn), zinc (Zn), lithium (Li), calcium (Ca), cesium (Cs), sodium (Na), potassium (K), iron (Fe), and manganese (Mn), and then it is dried and calcined at a temperature of between 700 and 1200° C., in such a way as to obtain a simple spinel MAl₂O₄ or a mixed spinel MₓM′₍₁₋ₓ₎Al₂O₄ that may or may not be partial, where M and M′ are separate metals and where x is between 0 and 1, with the values 0 and 1 themselves being excluded.

5. Method according to claim 4, characterized in that steps a′) and a″) are carried out simultaneously so as to introduce phosphorus and the metal M or M′ in a single step into said oxide substrate that is provided in step a).

6. Method according to claim 4, characterized in that the content of metal M or M′ is between 1 and 20% by weight in relation to the total mass of the final substrate.

7. Method according to claim 1, characterized in that a step d) for calcination is carried out at a temperature of between 320° C. and 460° C.

8. Method according to claim 1, characterized in that a reducing treatment step is carried out after step c) for treatment under vapor and/or step d) of calcination, at a temperature of between 200° C. and 600° C.

9. Method according claim 1, in which the content of metal of group VIIIB of the active phase of said catalyst is between 0.5 and 60% by weight in relation to the weight of said catalyst.

10. Method according to claim 3, in which the phosphorus content of the oxide substrate is between 0.1% by weight and 10% by weight in relation to the weight of said substrate.

11. Method according to claim 1, in which the active phase of said catalyst that comprises at least one metal of group VIIIB 15 cobalt.

12. Method according to claim 1, in which the specific surface area of the oxide substrate is between 50 m²/g and 500 m²/g, and in which the pore volume of said oxide substrate that is measured by mercury porosimetry is between 0.2 ml/g and 2.0 ml/g.

13. Method according to claim 1, in which the oxide substrate is a silica-alumina substrate.

14. Method according to claim 1, characterized in that step b) for impregnation of the substrate with the active phase comprises at least one step b′) for deposition of at least one dopant that is selected from among a noble metal of groups VIIB or VIIIB, an alkaline element (element of group IA), or an alkaline-earth element (element of group IIA), or an element of group IIIA, by itself or in a mixture, in said oxide substrate.

15. Method according to claim 1, in which the size of the catalyst particles is between 10 and 500 micrometers.
